(19) United States
(12) Patent Application Publication
(10) Pub. No.: US 2017/0225511 A1
(43) Pub. Date: Aug. 10, 2017

(54) Scooter Wheel

(71) Applicants: Daniel Barrett, Portland, OR (US); Eric Magray, Portland, OR (US)

(72) Inventors: Daniel Barrett, Portland, OR (US); Eric Magray, Portland, OR (US)

(21) Appl. No.: 15/401,031

(22) Filed: Jan. 8, 2017

Related U.S. Application Data
(60) Provisional application No. 62/293,754, filed on Feb. 10, 2016.

(51) Int. Cl. B60B 23/00; B60B 21/02; B60B 3/10; B60B 27/00; B60B 3/08

(52) U.S. Cl. CPC B60B 23/00; B60B 27/00; B60B 3/087; B60B 3/10; B60B 21/02

(57) ABSTRACT

A scooter wheel assembly consists of a rim which holds a tire and said rim having as its axial hole two tapers meeting at its mid-plane. The rim accepts two hub halves of which each is a frustum, such that clamping forces across the opposed conical surfaces of the pair of frusta firmly enforce concentricity between the axle and the rim and its tire. The rim and tire are connected to the axle exclusively by frictional coupling. Advantageously for changing a rim or tire, the hub parts can be quickly disassembled with common tools.

### PRIORITY: CROSS-REFERENCE TO THE RELATED APPLICATION

This non-provisional utility patent application claims the benefit of and priority to U.S. Provisional Application 62/293,754 “Scooter Wheel,” filed 10 Feb. 2016, and the entire content of said provisional application is incorporated into this document by reference.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The invention addresses current enhanced needs of scooter users by offering quick and easily understandable disassembly, interchangeability, and reassembly of hub components.

### BACKGROUND OF THE INVENTION

Although simple wheels of themselves predate recorded human history, improvements and unique modifications directed to specific uses have occurred and have been disclosed during the industrial revolution and continue currently.

In stark contrast to the simple wooden board, produce crate, and skate-wheel creations typically and primarily made and used by children of the early and mid-20th century, scooters as sports and recreation equipment are now enjoyed by persons well into young adulthood. These more sophisticated users subject scooters and scooter wheels to much more demanding environments than mere childs' play, including professional competitions.

Sophisticated scooter users also like to be able to select and modify wheel and tire configurations to match particular activities, environments, or ambient conditions, and they enjoy the option to change these configurations so as to readily and easily optimize their equipment at will.

In response to these modern demands, scooters now include composite materials and high-performance mechanical components and operate at higher speeds, accelerations, and forces, and are more likely to be used in intermittent free-fall. Scooter users now include persons of adult size and mass, and so scooter tires and the wheels which retain them are now subject to unprecedented and severe duty environments of rider load forces, lateral forces and braking forces, all contributing to accelerated wear in some tire materials of choice.

Furthermore, a new social activity among scooter users is to exchange tires and other components with other uses so that each may try another's configurations or materials, and discussions, observations, and performance trials of these diverse configuration become a basis of social intercourse.

This specification concentrates specifically on wheel assemblies designed for scooters, wherein components are easily and readily disassembled, modified, exchanged or replaced, and installed on scooters. Other wheel applications such as motor vehicles, pedal-powered vehicles, wheel barrows, carts for bulk transport, and wheels for outdoor machinery, and configurations such as solid hub wheels, spoke wheels and swivel caster wheels are thus generally outside the scope of the invention.

### INTRODUCTION AND SUMMARY OF THE INVENTION

The invention relates to wheels used for modern recreational scooters as technologically advanced and highly engineered sports and recreational equipment.

It is therefore a first objective of the invention is to provide to scooter users and owners a new kind of wheel comprising a hub, rim and tire assembly which can be quickly and easily disassembled and reassembled, especially for the purpose of exchanging tires, by any user especially including people of modest mechanical skill or strength.

Another objective of the invention is to offer a collection of a small or limited number of components which the user can mentally apprehend easily how these parts are to be assembled correctly; i.e, that by visual inspection or during disassembly, the proper method of reassembly becomes self-evident, especially when it is desired to exchange a worn tire for a new tire.

Another objective of the invention is to instill where possible into the assembly process aspects of poka-yoke, that is, prevention of improper assembly by designing components which can only be arranged into a correct assembly.

Another objective of the invention is to reliably establish and enforce concentricity of the rim with respect to its axis of revolution, and also to lock the hub halves, rim, and tire into a single rotatably coupled, unitary assembly. However, constraining the act of assembly of hub components to one or more discrete or specific angular alignments with respect to the is not necessary within the role of scooter wheels. Examples of such constrained assemblies are spoked wheels or and a typical automobile wheel, where a finite integer number of holes in a hub or rim engage with a complementary number of spokes or studs. The possible angular alignments of the tire to the axle is thus constrained to the number of spoke-receiving holes in a radial array of a hub or rim, or the integer count of a number of hub studs on any given pattern diameter of such a radial array, which register with complementary holes on some other component such as automobile wheels. It is thus a corollary objective of the invention to simplify the assembly process by eliminating the non-advantageous constraint of limiting the angular location of a rim with respect to a hub or axle to a finite set of arrangements. Such limitation adds no particular benefit to scooter wheel users disassembling and reassembling their wheels.

However, one other objective of the invention is to allow rotation of the wheel and its hub around an axle, while generating sufficient clamping forces and friction forces to prevent extraneous and unwanted movement or slipping of other parts with respect to each other, so as to eliminate unnecessary wear, noise, or unplanned or catastrophic disassembly of the assembles parts by mechanical failure. Thus when properly assembled and in use, the tire should not slip with respect to the rim, neither should the rim slip with respect to the affixed hub or hub parts, and threaded fasteners should not loosen of their own accord.

It is therefore a yet further objective of the invention to provide an assembly method by which the stresses in the rim and the tire are limited to within a known safe operating range for their materials.

Some people whose mechanical acumen is limited have difficulty with assembling asymmetrical parts, so a further objective of the invention is to avoid asymmetrical parts except where said asymmetry may act as a poka-yoke enforcement of a correct arrangement of parts.

Various modifications and additions can be made to the embodiments discussed without departing from the scope of the invention. For example, while the embodiments described above refer to particular features, the scope of this invention also includes embodiments having different combination of features and embodiments that do not include all of the above described features.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 shows an exploded view of the invention assembly

FIGS. 2a, 2b, and 2c show various rim cross section embodiments.

FIG. 3 shows two hub halves with complementary arrays of holes for fasteners.

FIG. 4 shows an end view of a hub half according to a preferred embodiment.

FIG. 5 shows a cross section of an assembly according to a preferred embodiment.

FIGS. 6a, 6b, and 6c show partial cross sections of various embodiments of a hub half of the invention.

FIGS. 7a through 7e show cross section of various embodiments of a rim of the invention.

FIG. 8 shows a cross section of a hub half having axial bosses and a counterbore for a bearing.

### DETAILED DESCRIPTION OF CERTAIN EMBODIMENTS

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

In this application the use of the singular includes the plural unless specifically stated otherwise, and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

Furthermore, in this specification the male grammatical gender subsumes the feminine gender as is common in Standard American English style manuals at least as late as 1971. Therefore “he” and “his” include “she” and “her” as equivalents, and the word “he” includes the meaning of both “she” and “he or she” and the word “his” includes the meaning of “her,” “hers,” “his or her,” and “his or hers.” Grammatical gender is a human language approximation of certain biological and physical constitutions, and the two grammatical genders in common English usage apply to all persons and users mentioned in this specification.

This invention fills a current need in that it can be desirable to sell wheels separately from hubs, reducing replacement costs. Also, tires of diverse materials and various tread patterns can be made available and these may be acquired and exchanged among users so that two or more people can try out one another's tires as a basis of social intercourse, or a scooter user may acquire a collection of different tires each suited to specific environmental demands, and this user can rapidly exchange and install tires particularly suited to any phase of his activity.

In a first embodiment simpler than others, the invention comprises a rim sandwiched between two hub halves and a tire immovably mounted to the exterior surface of the rim. The rim is of constant cross section throughout, and the primary aspect of its cross section is that it is an isosceles triangle with the apex of the two equal legs being closest to the axis of revolution. The circle described by the revolved apex defines a midplane of the rim and of the assembly. However, for practical manufacture, the apices of the revolved triangle may be chamfered, trimmed, or rounded slightly to eliminate sharp edges. The rim edges are therefore not theoretical sharp edges, but may be rounds of a finite radius or flats of a finite width. The pair of revolved surfaces of those two base legs form two addorsed conical or tapered holes which meet at the midplane. Both of the hub halves are conic frusta which are sized and tapered to insert into the tapers of the rim.

“Addorsed” is generally a heraldic term, but as used in this specification it means “positioned back to back” or “facing away from each other.” Two objects addorsed do not necessarily touch each other, but they do define a midline or a midplane. These and other heraldic adjectives may follow the noun they modify. Heraldic terms including “vair” and other terms to be encountered further below in this specification are used because these words concisely, exactly, and efficiently describe specific contours having compound, complex, or multiple elements.

The hub halves are fastened together by mechanical fasteners passing through a first array of holes in one hub half aligned with a second complementary array of holes in the other hub half. Actuating the mechanical fasteners such as by applying a torque to a threaded fastener will draw the hub halves together and towards eventual mutual contact, or contact of each hub half with an intervening or interposed portion or midplane feature on the interior of the rim. The squeezing force between the hub halves locks the hub halves to the rim by the coefficient of static friction between the mated surfaces. The four tapered surfaces in contact—two of the rim and one on each hub half—all cooperate to coaxially align the hub halves and the rim and also to angularly fix the rim and the tire with respect to said hub halves. The squeezing force developed by the mechanical fasteners acts is converted by conical or tapered surfaces into radial force which expands the rim. This radial expansion creates hoop stress in the rim, and the equal and opposite reaction to the stress is an inward radial pressure applied from the rim onto the tapered surfaces of the hub halves. In an ideal assembly, the hoop stress in the rim remains below a predetermined margin of safety for the rim material, and the inward radial pressure applied to the hub halves is sufficient to frictionally couple them both to the rim, so that relative rotation between the rim and hub halves is prevented.

The hub halves include additional features including counterbored central holes where the scooter axle may pass, and which may receive axle bearings and other mechanical parts outside the scope of the invention. After disassembly of its parts, assembling a wheel assembly according to the invention follows the easy steps of:

inserting a first of two hub halves into the rim and mating the conical surface of the frustum of said first hub half to either of the two congruent conical surfaces of the rim,

inserting the second hub half and mating its conical frustum surface to the other conical surface of the rim,

rotating one hub half with respect to the other hub half until the array of apertures in the first hub half align and register with the array of apertures in the second hub half, and

installing mechanical fasteners through at least any three of the aligned arrays of holes and tightening them each to a predetermined tension, so that the rim, tire, and both hub halves become coaxially aligned.

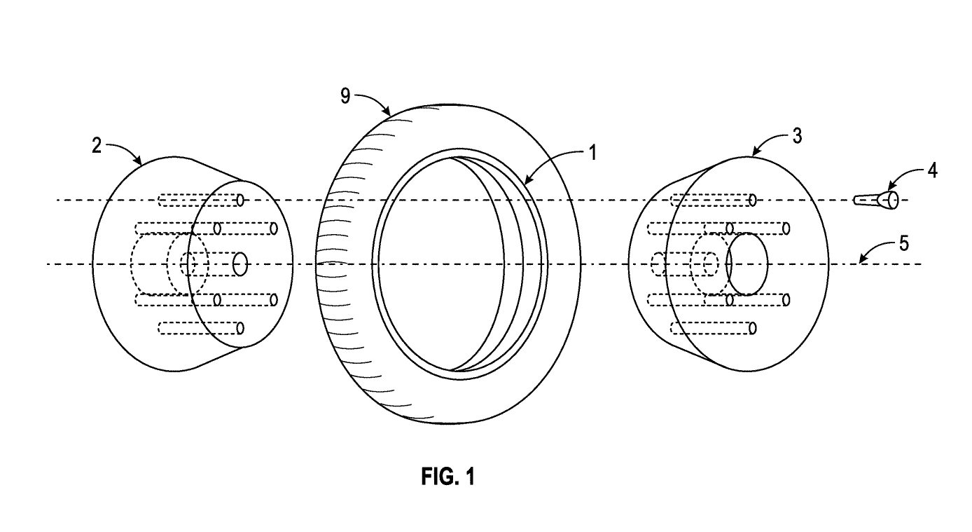

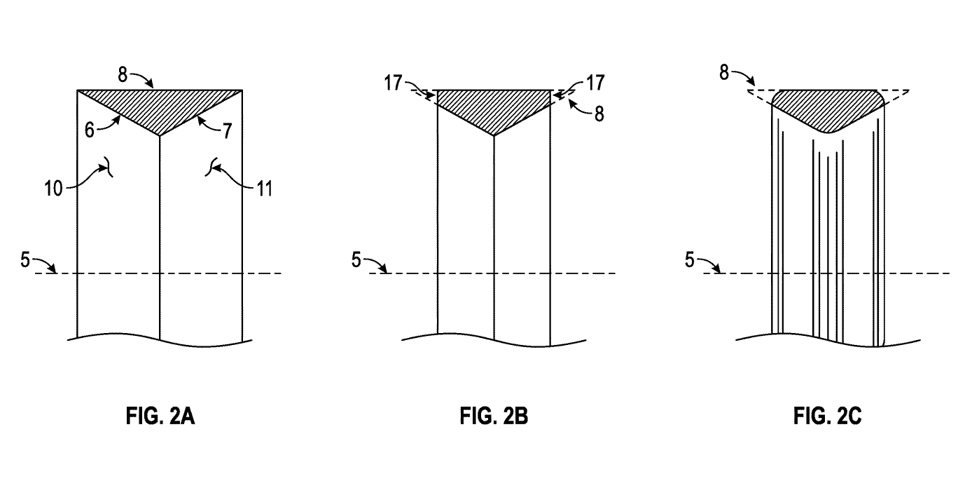

Beginning with FIG. 1, a simpler embodiment in accordance with the invention is a hub assembly for a scooter wheel comprising a rim [1] sandwiched by fasteners [4] between two hub halves [2,3] and a tire [9] immovably mounted to the exterior surface of the rim. The rim is formed by a rotation of its cross section about an axis of revolution [5] which also defines the axis of revolution of the entire assembly when all parts are mutually rotatably coupled. The rim is of constant cross section substantially throughout, and FIG. 2a shows the primary aspect of its cross section as an isosceles triangle [8] with the apex of the two equal legs [6,7] being closest to the axis of revolution [5.] Therefore the rim has two addorsed, outwardly facing conical or tapered surfaces [10] and [11.] Each conical or tapered surface in this specification may also be called a frustum surface. In FIG. 2b, the isosceles triangle [8] is shown as a phantom line because for practical manufacture, the apices of the revolved triangle may be chamfered, trimmed, or rounded slightly to eliminate sharp edges. Thus, FIG. 2b shows a preferred embodiment with two chamfers [17] on the apices which are not in the midplane, and FIG. 2c shows an additional embodiment in which all three apices are rounded.

The pair of revolved surfaces of those two base legs form two addorsed conical or tapered holes which meet at the midplane. These two surfaces are indicated as [10,11] in FIG. 2a.

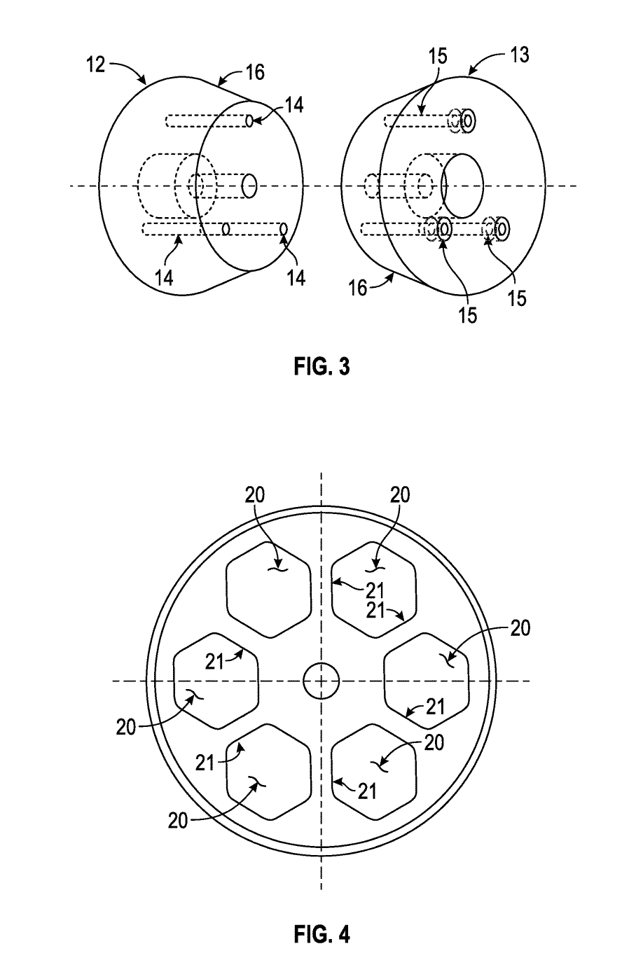

FIG. 3 shows both of the hub halves [12,13] as conic frusta which having taper edges which are sized and tapered to insert into the tapers of the rim. The hub halves are fastened together by mechanical fasteners passing through a first radial array of holes [14] in one hub half aligned with a second complementary set of holes [15] in the other hub half. Although the rim and tire are omitted from FIG. 3, in this figure it can be understood that the squeezing force between the hub halves locks the hub halves to the rim by the coefficient of static friction between the mated surfaces. Also seen in FIG. 3 is a preferred embodiment comprising threaded holes in the first array [14] and counterbored holes in the second array [15,] but other embodiments using mechanical fasteners received into the aligned complementary arrays of the hub halves are also included within the invention, such as two arrays of counterbored holes able to receive threaded screws in one array and nuts or jam nuts in the other array.

Also in FIG. 3 the hub halves each have an inner circular face and an outer circular face which is larger in diameter than said inner circular face. The outer face and inner face are spaced apart by the thickness of a hub half, which also means that the circular perimeter of the hub must include a change in diameter such as a tapered or conical surface [16] spanning across at least a part if not all of its thickness, and for this specification said conical surface of said circular perimeter is also called a taper edge.

FIG. 4 shows an end view of one embodiment of a preferred hub half. In the best mode of the invention, the material of a hub half is removed in a radial array of pockets [20] to reveal spokes [21.] The pockets may extend to a partial depth of the thickness of the hub, leaving a membrane of material either medial or lateral to the assembly midplane, but in the best mode the pockets pierce the hub entirely leaving only a radial array of spokes. The number of pockets equals the number of spokes and may be any number from two to a large integer, but within a more practical range of three to eleven spokes, the most preferred number of spokes [21] (and pockets [20]) is five.

Nevertheless, further embodiments include a set of pockets defining spokes on one side of a membrane and an identical or a different set of pockets on the other side so that the membrane resides anywhere within the thickness of a hub half. Any radial array of pockets will further define the material residing between every two adjacent pockets to form a radial array of spokes.

The contour of the spokes may be straight in a radial direction or may be angled, curved, sinusoidal, Z-shaped, or be of any contour curve leading from near the axis of revolution towards the rim. Curved and sinusoidal spokes may be preferable when the hub half is a cast metal part or an injection molded part so as to relieve thermal stresses, or they may be selected for a decorative or aesthetic appeal. Spoke contours may pass through each other so as to create filigree or a grilled appearance. Furthermore, spokes of the invention may be of any cross section, and even furthermore, although the first hub half and second hub half include complementary arrays of apertures for fasteners, for example one hub half may receive threaded fasteners which engage in threaded holes in the other hub half, yet either or both may have different spoke and pocket features, or decorative features or indicia, and these other features need not be symmetrical or identical from the first hub half to the second hub half.

Although it is possible to vary the shape and size of the pockets in an alternating series around the radial array so as to gather spokes into pairs, triplets, quadruplets, or even mixed series of collections of spokes, the preferred embodiment is to have five radially straight spokes, with rounds or fillets at their ends to reduce stress concentrations. The most preferred pocket shape is a nearly regular hexagon having rounded corners, as illustrated in FIG. 4.

Although the scope of the invention includes a pair of hub halves of a thickness such that in assembly the smaller diameters of both frusta meet at the midplane, in one embodiment the hub halves remain just shy of this thickness so that when addorsed in the assembly a gap between the hub halves remains at the midplane, so the sum of the tension forces created by the fasteners and sandwiching the hub halves is transferred in full brunt to the conical tapered inner surfaces of the rim, thus maximizing the centralizing effect and maximizing static friction between the hub halves and the rim so as to maximally prevent unwanted rotation of the rim with respect to the hub halves.

In the most preferred embodiment, when the parts are assembled but the fasteners are loose, there is a predetermined gap between the planar faces of the frusta located nearest to the assembly midplane. However, this gap is designed to disappear when the fasteners are tightened, because the best embodiment also uses materials for the rim and tire which deform under hoop stress. The predetermined width of the gap allows a specified amount of force to mate the hub halves to the rim. As the fasteners are tightened, the gap closes and force is translated to produce hoop stress in the rim and the tire. Once the hub halves meet and the gap closes in the immediate vicinity of the fasteners, or by the hub, or at both of these locations, further tightening of the fastener can no longer force the diameter of the rim and tire to expand any more, so the hoop stress in the rim and tire will plateau within a safe operable limit for those materials even if excess fastener torque continues to be applied. Yet, advantageously, the resulting opposition by the rim of hub expansion force frictionally locks the rim to the hubs' frusta and thus prevents rotational slipping of the rim with respect to the hubs.

In one embodiment of the invention, complete insertion of a hub half into a tapered hole brings the larger diameter face of the hub half into coplanar alignment with the outer edge or outer edge face of the hub, however to prevent scuffing, one face may be preferred over the other, and the hub half thickness can be made greater or lesser to control which feature is more exposed to abrasion and impacts of its working environment. Other embodiments which will be examined further below in this specification have a rim which includes extra flanges extending axially from the conical surfaces which receive the hub halves, so that these flanges can taper to a thin, outward-facing ring edge.

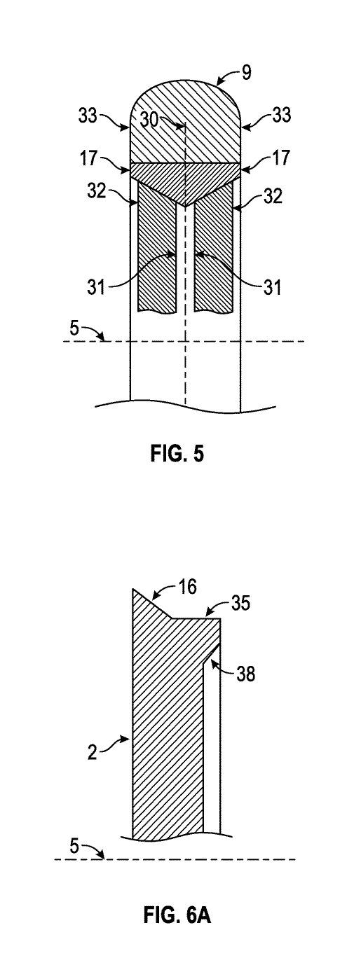

Another particular embodiment is shown in cross section in FIG. 5 where the midplane [30] appears as a centerline and the rim cross section is chamfered to include an end face [31] axially offset from the midplane by one extent, and the thickness and taper of the hub half are predetermined of so that the larger diameter, outward-facing surface [32] of the hub half as seated within the rim is offset from the midplane by a lesser extent. It is preferred that the end faces of the rim [17] and perhaps the tire sidewall [33] as well be more subject to scuffing, general wear, environmental impacts, and damage or deterioration of markings or graphics which may adorn these surfaces. Further embodiments directed toward the cosmetic protection of certain surfaces are explained further below. For additional reference, the rotational axis [5] and the tire item [9] are also included.

Although in one embodiment the conical taper of the hub half frusta are the same as the conical tapers of the rim inner surfaces, this is not necessarily so, and embodiments included in the invention are those in which a greater taper of one part meets a lesser taper of the other so that rather than a general cone to cone contact, a narrow, focused circular line contact is obtained.

In a preferred embodiment, the rim is made of a deformable material so that its inner conical tapers are initially not the same taper as the exterior conical surfaces of the half rims, but as the half rims approach and meet at the midplane they define, the hoop stress imparted to the rim deforms and its inner conical tapers become complementary to those of the mated half rims.

The profile of the base leg of the isosceles triangle which defines the cross section of the rim may be supplemented with individual crenels or merlons which create grooves or ribs in the outer surface of the rim to afford a strong purchase of the tire to the rim and prevent the tire from rotational slipping or from axial slipping or of coming off the rim entirely. Additionally, within the scope of the invention is any arbitrary profile of the base leg, or the profile of any outwardly facing surface of a rim, wherein to enhance gripping of the tire to the rim said profile may be flat, convex, or concave, and may also be further enhanced along any part said profile or along its entirety with profiles described by heraldic divisions of field, such as: wavy, nebuly, dove-tailed, potenty (T-slots) embattled (square grooves) indented (sawtooth) urdy, engrailed, invected, raguly, dancetty, and rayonne.

As mentioned above, other rim shapes included within the scope of the invention include rims having additional flanges extending axially farther beyond the tapered surfaces. It is preferable but not strictly necessary that the cross section of the rim be symmetrical about the its midplane or a plane passing between the center of the gap between the closest approach of the addorsed conical surfaces of the rim so that assembly can proceed with either hub half inserted into either side of the rim.

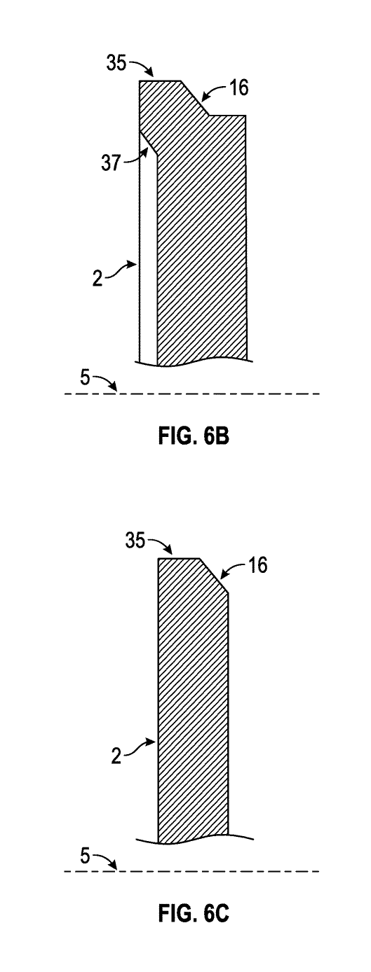

FIGS. 6a, 6b, and 6c show additional embodiments of a hub half [2] in partial cross section, including a centerline [5] showing the rotational axis of symmetry for the section. Spoke features and pockets described elsewhere are omitted in these particular views. As previously mentioned in the discussion of FIG. 3, the surface spanning the unequally sized inner and outer faces of a hub half must include a change in diameter such as a tapered or conical surface [16] spanning across at least a portion of if not all of its thickness. However, other portions of the hub perimeter may include cylindrical or filleted faces, or step changes in diameter or any other revolved surface. FIG. 6a shows a taper edge [16] starting with a larger diameter and leading to a cylinder section [35] of a smaller diameter. FIG. 6b shows a larger cylinder section [35,] a taper edge [16,] and a cylinder section of a smaller diameter. FIG. 6c shows a taper edge [16,] originating at the larger diameter but at a point spaced inward from the outer face of the hub, and the taper edge [16] tapering down to a smaller diameter of the inner face of the hub.

Besides pockets and spokes described previously, the thickness of a hub half may increase at its perimeter to form a raised circular perimeter flange. This flange can be made as an inward facing perimeter flange [38] of FIG. 6a or an outward facing perimeter flange [37] of FIG. 6b. A hub half in accordance with the invention may incorporate either or both of these perimeter flange features. Thus, many operable variations in the cross section of the hub reside within the scope of the invention.

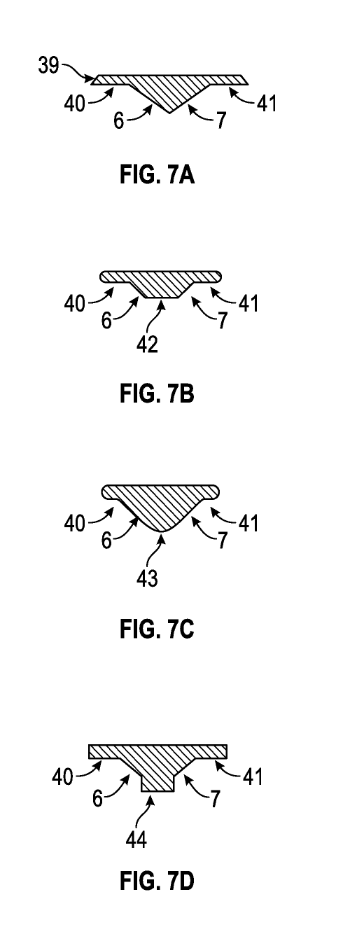

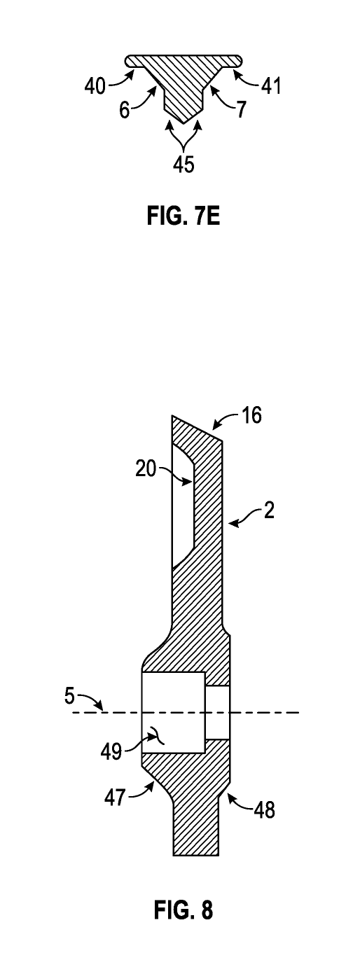

FIGS. 7a through 7e show additional variant embodiments of the rim in cross section. It will be understood that the centerline or axis of rotation of each of these cross sections is beneath them, without being explicitly shown. The rim of FIG. 7a, the same as any rim in all cases, includes addorsed outwardly facing conical or tapered surfaces [6] and [7,] but in this set of embodiments additional rim material extends as rim membranes [40, 41] axially past these chamfers and axially farther beyond an inserted or installed hub half to terminate at a ring edge [39.] The ring edge terminating a rim membrane may be rounded, squared off, or have its own taper or chamfer. The rim membrane extends the ring edge axially farther beyond the midplane than any portion of an installed tire, so that the ring edge cosmetically protects the wheel assembly, because scuff marks collected while in service will reside primarily on the end or edge surface of the ring edge. This visible endwise area of the ring edge is a very small fraction of the total visual area of the entire wheel assembly, so that by confining wear marks and scratches to a rim edge, other parts of the assembly look new and relatively unblemished for a longer service life. Labels, logos, indicia, and other graphic elements applied to the sidewall of the tire or to the hub halves are also thus protected and remain recognizable and new-looking over a longer service life.

Similarly, a rim including a rim membrane extending away from the midplane axially farther beyond a hub half protects the outward facing surface of that hub half from scuffs and scratches in service, so that labels, logos, indicia, and other graphic elements applied to the hub are also preserved from visual deterioration.

FIG. 7b shows a cross section of an embodiment of a rim which includes addorsed outwardly facing conical or tapered surfaces [6] and [7,] additional rim membranes [40, 41] extending axially from said conical surfaces, and the inner limits of the conical surfaces are bridged by a cylindrical surface [42] of a minimum diameter of the rim.

FIG. 7c shows a cross section of an embodiment of a rim which includes addorsed outwardly facing conical or tapered surfaces [6] and [7,] additional rim membranes [40, 41] extending axially from said conical surfaces, and the inner limits of the conical surfaces are bridged in cross section by a fillet [43] substantially tangent to said conical surfaces and which forms an annulus and defines a minimum diameter of the rim.

FIG. 7d shows a cross section of an embodiment of a rim which includes addorsed outwardly facing conical or tapered surfaces [6] and [7,] additional rim membranes [40, 41] extending axially from said conical surfaces, and the inner limits of the conical surfaces are bridged in cross section by a rectangular abutment [44] which forms a cylinder of a minimum diameter of the rim.

FIG. 7e shows a cross section of an embodiment of a rim which includes addorsed outwardly facing conical or tapered surfaces [6] and [7,] additional rim membranes [40, 41] extending axially from said conical surfaces, and the inner limits of the conical surfaces meet with the larger or outer perimeters of annular flat ring surfaces. At the inner perimeters of these annular flat surfaces a second pair of addorsed outwardly facing conically tapered surfaces [45] arise and are conjoined at their inner, smaller diameter to define a circular edge residing in the midplane of the rim. Thus two pairs of outwardly facing conically tapered surfaces happen to comprise a contour known by the heraldic term ‘vair.’ Thus, there are many operable variations in the cross section of the rim which reside within the scope of the invention.

FIG. 8 shows a cross section of a hub half [2] having axial bosses [47, 48,] each of which arise from the perimeter of a central aperture. This hub as shown also has a counterbore [49] designed to receive and retain a bearing such as a ball bearing or a journal bearing. The taper edge [16] and a partial depth pocket [20] are also seen. Although both axial bosses [47] and [48] are present in this figure, a hub half of the invention may have only one such boss, or neither boss. The counterbore may further include additional features for retaining a bearing installed therein, such as an internal groove for a snap ring, or threads to receive a threaded member for axially fixing the bearing within its hub.

However, the inward facing boss [48] may protrude inwardly to a predetermined extent so that as explained previously, the mechanical drawing together of two hub halves by means of their mechanical fasteners will cause the taper edges to expand the rim and build hoop stress in the rim until the inward facing bosses to meet, cannot approach any more, and arrest any further build-up of hoop stress in the rim beyond a certain predetermined extent. Thus, there are many operable variations in the cross section of the hub halves which reside within the scope of the invention.

While certain features and aspects have been described with respect to exemplary embodiments, one skilled in the art will recognize that numerous modifications are possible. Further, while various methods and processes described herein may be described with respect to particular structural and/or functional components for ease of description, methods provided by various embodiments are not limited to any particular structural and/or functional architecture.

Hence, while various embodiments are described with or without certain features for ease of description and to illustrate exemplary aspects of those embodiments, the various components and/or features described herein with respect to a particular embodiment can be substituted, added, and/or subtracted from among other described embodiments, unless the context dictates otherwise. Consequently, although several exemplary embodiments are described above, it will be appreciated that the invention is intended to cover all modifications and equivalents within the scope of the following claims.

1. a wheel assembly for a scooter comprising:
a circular rim defining an axis,
at least one mechanical fastener; and
two circular hub halves, wherein said hub halves have
a central aperture, and
at least one aperture in each hub half adapted to receive said mechanical fastener; and
with said rim further comprising at least two inner faces frictionally engageable with said two hub halves, and
when said hub halves are placed into mating physical contact with said rim and
said at least one mechanical fastener is engaged between said hub halves to develop a squeezing force to draw said hub halves toward mutual contact,
a hoop stress and an inward radial pressure is developed in said rim,
so as to frictionally couple both of said hub halves to said rim.

2. The wheel assembly of claim 1, wherein said mechanical fastener is a threaded fastener.

3. The wheel assembly of claim 1, wherein both hub halves each further comprise a frustum surface residing between an outer face having a first diameter and an inner face having a second diameter smaller than said first diameter,
with said outer face and said inner face spaced apart by a thickness.

4. The wheel assembly of claim 3, wherein said frustum surface of a hub spans the entire thickness between said outer face and said inner face of said hub.

5. The wheel assembly of claim 1, wherein at least one hub half further comprises an axial boss arising from the perimeter of said central aperture.

6. The wheel assembly of claim 1, wherein said rim further comprises two addorsed, outwardly-facing frustum surfaces which further define a midplane between said frustum surfaces.

7. The wheel assembly of claim 6, wherein a cross section of said rim is symmetrical about said midplane.

8. The wheel assembly of claim 6, wherein said outwardly-facing frustum surfaces each further comprise an outer perimeter, and
from at least one of said outwardly-facing frustum surface perimeters a rim membrane extends axially away from said midplane and
terminates with a ring edge.

9. The wheel assembly of claim 8, wherein a rim membrane extends axially away from said midplane axially farther beyond a hub half.

10. The wheel assembly of claim 8, further comprising a tire affixed to said rim, with
at least one rim membrane extending axially farther beyond said midplane than any portion of said tire.

11. A wheel assembly for a scooter comprising:
a circular rim defining an axis,
at least one mechanical fastener; and
two circular hub halves each with a central aperture formed therethrough,
wherein at least one hub half further comprises at least one aperture adapted to receive said mechanical fastener,
wherein at least one hub half further comprises at least one raised circular perimeter flange,
wherein said hub halves each have
an inner face with an inner diameter and
an outer face with an outer diameter larger than said inner diameter, and
a thickness between said inner face and said outer face.

12. The wheel assembly of claim 11, wherein at least one hub half further comprises at least one raised circular perimeter flange.

13. The wheel assembly of claim 11, wherein at least one hub half further comprises at least one radial array of pockets cut into said thickness of said at least one hub half,
said pockets further defining the material residing between every two adjacent pockets as a radial array of spokes.

14. The wheel assembly of claim 13, wherein a depth of at least one pocket extends partway through a thickness of a hub half.

15. The wheel assembly of claim 13, wherein at least one pocket extends through the entire thickness of a hub half.

16. The wheel assembly of claim 11, wherein
an array of fastener receiving apertures of a first of said to halves further comprise counterbores, and
a complementary array of fastener receiving apertures in a second of said hub halves are threaded to at least a portion of their depths.

17. The wheel assembly of claim 11, wherein at least a portion of a cross section of an outwardly facing surface of said rim further comprises a profile selected from the set of profiles consisting of:
a straight line, a concave profile, a convex profile, a wavy profile, a nebuly profile, a dove-tail profile, a potenty profile, a crenel profile, a merlon profile, an embattled profile, an indented profile, a sawtooth profile, an urdy profile, an engrailed profile, an invected profile, a raguly profile, a dancetty profile, and a rayonne profile.

18. A method of assembling into coaxial alignment a scooter wheel assembly comprising a tire, a rim, and a first and a second of two hub halves, comprising the steps of:
a. inserting a first of two hub halves into a rim and mating a taper edge of said first hub half to a surface of said rim,
b. inserting a second hub half and mating a taper edge of said second hub half to a surface of said rim,
c. rotating a first hub half with respect to a second hub half until an array of apertures in said first hub half align and register with an array of apertures in the second hub half,
d. installing mechanical fasteners through at least two of said aligned and registered apertures, and
e. tightening said mechanical fasteners to at least a predetermined tension.

19. The method of claim 18, wherein after performing step e, a gap remains between said two hub halves.

20. The method of claim 18, wherein before step e, a gap exists between said two hub halves, and said gap is closed after step e.

21. The method of claim 16, wherein a diameter of said rim before the step e is smaller than said diameter of said rim after step e.
